(19) United States
(12) Patent Application Publication
(10) Pub. No.: US 2004/0029527 A1
(43) Pub. Date: Feb. 12, 2004

(54) Power supply control method and device in portable communication device

(75) Inventor: Etsuro Endo, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/633,833

(22) Filed: Aug. 4, 2003

(30) Foreign Application Priority Data
Aug. 5, 2002 (JP) 2002-228041

(51) Int. Cl. H04B 7/15

(52) U.S. Cl. 455/11.1; 455/13.4; 455/422.1; 455/522

(57) ABSTRACT

A power supply control method in a portable communication device achieves reduced power consumption. A main CPU sends an operation check request to a sub CPU. When the sub CPU performs radio communication for location registration, the sub CPU sends an operation check response back to the main CPU. When the time required from transmission of the operation check request to reception of its response exceeds a predetermined time-out period or the response fails to be received within the predetermined time-outperiod, it is determined that no external communication is performed by the sub controller and therefore the sub controller is powered off.

### BACKGROUND OF THE INVENTION

1. Field of the Invention

The present invention relates to a portable communication device such as a mobile telephone terminal or a portable information processing terminal and in particular to techniques of controlling the power supply of a portable communication device equipped with a plurality of controllers.

2. Description of the Related Art

In a mobile communications system as shown in FIG. 1, a plurality of base stations 10 each labeled with “BS” are distributed over service areas SA, SB. The respective base stations 10 form radio zones Z1, Z2, . . . , in which mobile stations (MS) 20 can communicate with nearest base stations (BS) using predetermined or assigned radio channels. In FIG. 1, the base stations 10 in the service area SA are connected to a visit mobile control center (VMCC) 30 and the base stations 10 in the service area SB are connected to a VMCC 40. The VMCCs 30 and 40 are further connected to a gateway mobile control center (GMCC) 50, which is connected to an existing fixed network such as a public switched telephone network.

In a mobile station 20 such as a mobile telephone or mobile information terminal (e.g. PDA: Personal Digital Assistant), a first program-controlled processor (main CPU) controls the entire operation thereof and a second program-controlled processor (sub CPU) controls an external communication operation such as radio communication under the control of the main CPU. In such a mobile station, which may be battery-powered, it is preferable to reduce its power consumption as much as possible. Accordingly, there have been proposed several techniques intended to reduce in power consumption.

Japanese Patent Application Unexamined Publication No. 7-183976 discloses a facsimile machine equipped with a main CPU and a sub CPU. In this facsimile machine, the sub CPU takes charge of power supply control. When facsimile operations including line connection, document reading and printing have been completed, the main CPU instructs the sub CPU to turn off a main power supply.

Japanese Patent Application Unexamined Publication No. 2000-347985 discloses a portable radio terminal which is equipped with a main CPU for control the entire operation of the terminal and a sub CPU for monitoring a SLEEP control task.

However, as known well, a battery-powered mobile station transmits and receives control signals at regular intervals or as necessary to and from a corresponding VMCC through a nearest base station to perform its location registration, handover operation, and the likes. The sub CPU may take charge of controlling operations related to the external communication control such as location registration. In such a circuit structure, it is necessary for the sub CPU to control radio transmission and reception of control signals for location registration and the likes at all times or regular intervals. This increases power consumption, resulting in reduced lifetime of a battery. It is the same with a mobile station connected to an external device such as a personal computer by a cable.

### SUMMARY OF THE INVENTION

An object of the present invention is to provide a power supply control device and method, which allow reduced power consumption in a portable communication device equipped with a plurality of controllers.

According to the present invention, a power supply control method in a portable communication device provided with a plurality of controllers including a main controller and a sub controller for controlling external communication, includes the steps of: a) checking whether the sub controller is performing the external communication; and b) when the external communication has not been performed for a predetermined time-out period, powering off the sub controller.

The external communication may be radio communication with a mobile communications system for location registration of the portable communication device. The external communication may be wired communication with an external information processing device through an external connector.

The step a) preferably includes the steps of: a.1) sending an operation check request to the sub controller when an operation check timer is reset for the predetermined time-out period; and a.2) determining whether an operation check response to the operation check request is received from the sub controller, and the step b) preferably includes the steps of: b.1) when the operation check response is not received from the sub controller within the predetermined time-out period, powering off the sub controller; and b.2) when the operation check response is received from the sub controller within the predetermined time-out period, keeping the sub controller powered on.

The power supply control method may further include the steps of: implementing at least an external interface task and timer handler in the main controller; and implementing at least an external communication monitoring task in the sub controller, wherein the external interface task sends the operation check request when the timer handler starts the operation check timer and, when the operation check response is not received from the sub controller within the predetermined time-out period, powers off the sub controller, wherein the external communication monitoring task sends the operation check response back to the external interface task when the external communication is being performed.

According to another aspect of the present invention, a portable communication device includes: a radio communication section for communicating with a base station of a mobile communications system; a main CPU for controlling an entire operation of the portable communication device; a sub CPU for controlling external communication; a dual port memory connected to the main CPU at one port and connected to the sub CPU at the other port, for transferring messages between the main CPU and the sub CPU, wherein the main CPU implements: operation check means for checking whether the sub controller is performing the external communication; and power control means controlling power supply of the sub controller such that the sub controller is powered off when the external communication has not been performed for a predetermined time-out period, wherein the sub controller implements: response means for sending the operation check response back to the main controller when the external communication is being performed.

As described above, according to the present invention, when the time required from transmission of the operation check request to reception of its response exceeds the predetermined time-out period or the response fails to be received within the predetermined time-out period, it is determined that no external communication is performed by the sub controller and therefore the sub controller is powered off. Accordingly, power consumption can be reduced, resulting in elongated lifetime of the battery.

### BRIEF DESCRIPTION OF THE DRAWINGS

FIG. 1 is a schematic diagram showing an example of a network configuration in which a portable telephone according to the present invention may be used;

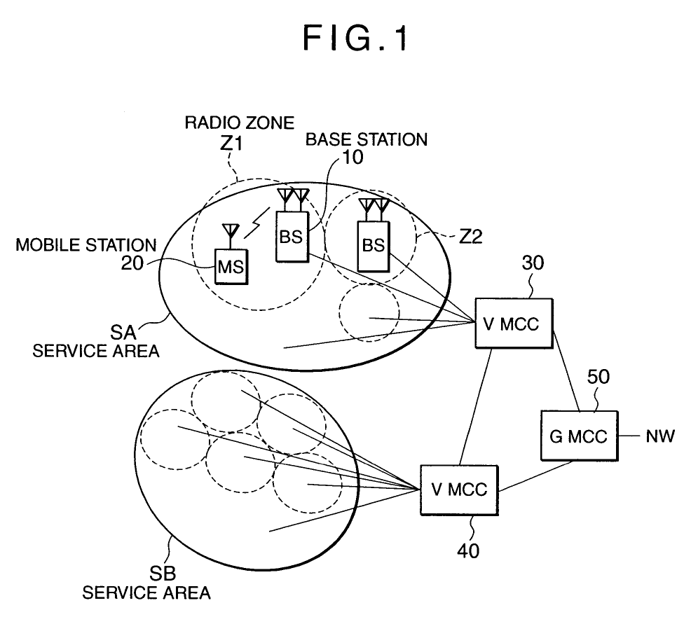

FIG. 2 is a block diagram showing a mobile telephone device according to an embodiment of the present invention;

FIG. 3 is a block diagram showing functional blocks of a main CPU and a sub CPU in the mobile telephone device according to the embodiment of the present invention;

FIG. 4 is a sequence diagram showing message transfer between tasks implemented in the main CPU and the sub CPU in the mobile telephone device according to the embodiment of the present invention;

FIG. 5 is a sequence diagram showing a first example of normal message transfer between tasks implemented in the main CPU and the sub CPU;

FIG. 6 is a sequence diagram showing a second example of normal message transfer between tasks implemented in the main CPU and the sub CPU;

FIG. 7 is a sequence diagram showing a third example of normal message transfer between tasks implemented in the main CPU and the sub CPU;

FIG. 8 is a sequence diagram showing a first example of failed message transfer between tasks implemented in the main CPU and the sub CPU to start a sub CPU reset operation;

FIG. 9 is a sequence diagram showing a second example of failed message transfer between tasks implemented in the main CPU and the sub CPU to start the sub CPU reset operation;

FIG. 10 is a sequence diagram showing a third example of failed message transfer between tasks implemented in the main CPU and the sub CPU to start the sub CPU reset operation; and

FIG. 11 is a sequence diagram showing a fourth example of failed message transfer between tasks implemented in the main CPU and the sub CPU to start the sub CPU reset operation.

### DESCRIPTION OF THE PREFERRED EMBODIMENTS

Preferred embodiments of the present invention will be described hereinafter, taking a mobile telephone as an example.

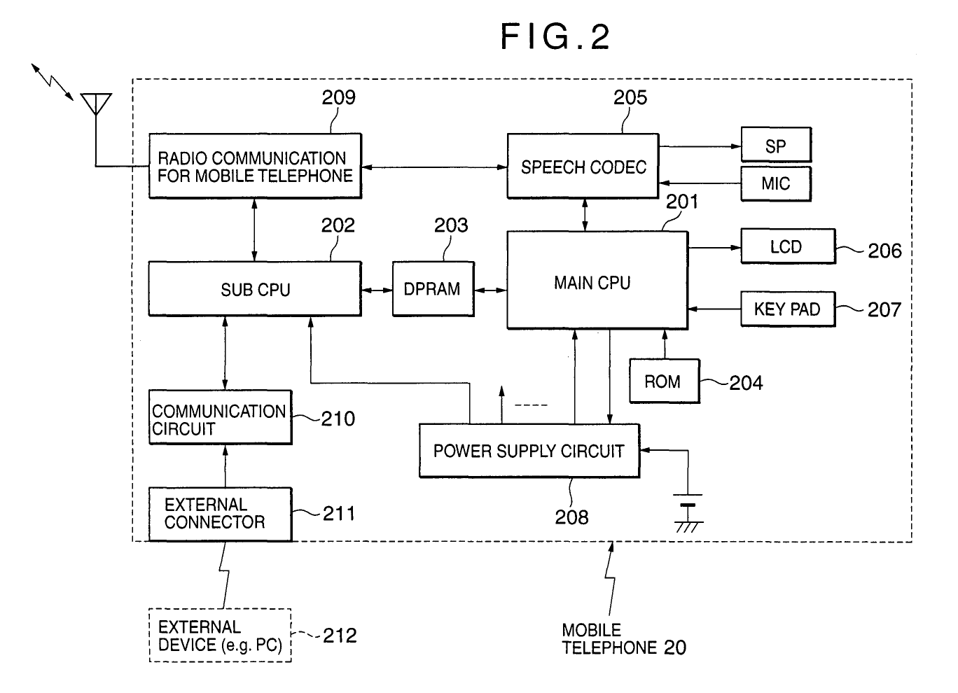

Referring to FIG. 2, a mobile telephone 20 according to an embodiment of the present invention is equipped with a first controller (here, main CPU) 201 and a second controller (here, sub CPU) 202, which are connected by a DPRAM (Dual Port RAM) 203 so that the main CPU 201 performs control operations including an operation check of the sub CPU 202. The operation check, which will be described later, is to monitor an external communication operation of the sub CPU 202 so as to determine whether the halt time period during which the sub CPU 202 does not perform any external communication control exceeds a predetermined time-out period. The DPRAM 203 has two ports each connected to the main CPU 201 and the sub CPU 202, allowing the main CPU 201 and the sub CPU 202 to obtain access to the DPRAM 203 concurrently while one reading data and the other writing data. Accordingly, the DPRAM 203 is used to transfer data at high speed between the main CPU 201 and the sub CPU 202. The DPRAM 203 has a control memory area which stores an operation check reset flag indicating that the sub CPU 202 is reset by the operation check processing.

The main CPU 201 is a program-controlled processor, on which control programs including an operation check program run to implement necessary tasks, which will be described later. The control programs are stored in a ROM 204. The main CPU 201 is connected to or incorporates a timer and a clock generator, which are not shown. The main CPU 201 may also be a program-controlled processor.

The main CPU 201 is connected to a speech CODEC 205 connected to a telephone receiver (speaker) and a telephone transmitter (microphone), a display 206 such as LCD (liquid-crystal display), and an input device 207 such as a keypad including a ten-key. The main CPU 201 controls a power supply circuit 208 to selectively supply power to the sub CPU 202, a radio communication system 209, and other components. Under the control of the main CPU 201, the radio communication system 209 and the speech CODEC 205 are used to perform voice communication.

The sub CPU 202 controls the radio communication system 209 to perform radio communication for mobile telephone and further controls an external communication circuit 210, which is connected to an external connector 211. The external connector 211 may be connected to an external device 212 such as a personal computer. In other words, the sub CPU 202 performs the external communication control by controlling the radio communication system 209 or the external communication circuit 210. The external communication operation of the sub CPU 202 includes transmitting and receiving control signals to and from an external device 212 or a nearest base station (BS) for the location registration of the mobile telephone 20. As will be described later, the sub CPU 202 monitors the radio communication system 209 to determine whether control signals for location registration, handover or the like are transmitted and received to and from the VMCC through a nearest base station (BS).

The main CPU 201 monitors the external communication operation of the sub CPU 202 to determine whether the halt time period during which the sub CPU 202 does not perform any external communication control exceeds a predetermined time-out period. When the halt time exceeds the predetermined time-out period, the main CPU 201 instructs the power supply circuit 208 to stop supplying power to the sub CPU 202. Hereafter, the operation check will be described in detail.

### Operation Check

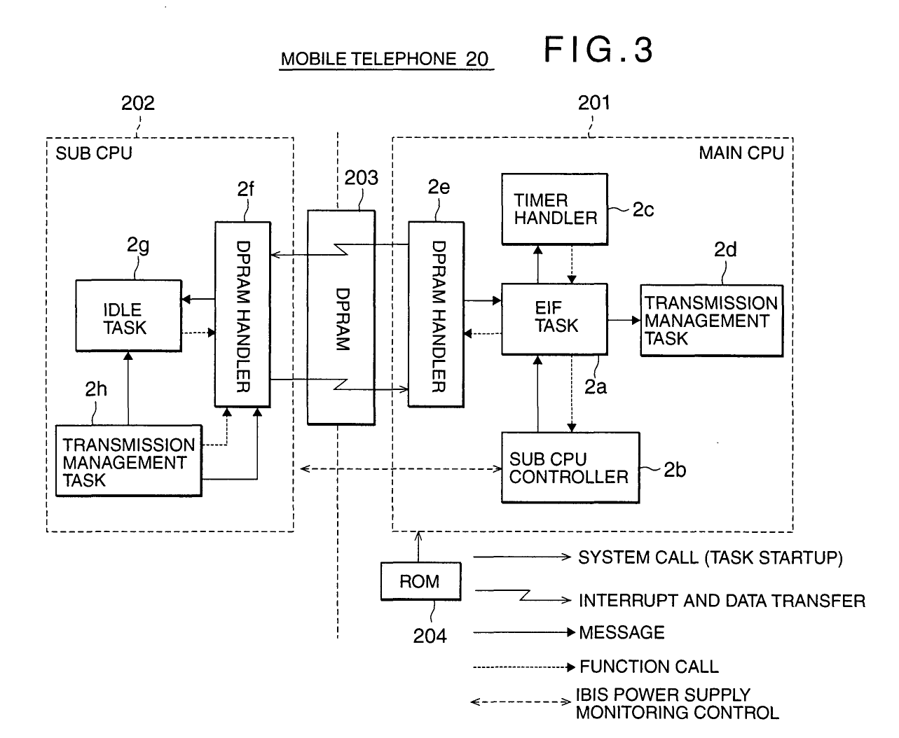

Referring to FIG. 3, the main CPU 201 implements an external interface (EIF) task 2a, a sub-CPU controller 2b, a timer handler 2c, a transmission management task 2d, and a DPRAM handler 2e. The EIF task 2a issues a primitive, or an operation check request message, to the sub CPU 202 at predetermined time intervals and waits for a response.

As described later, when no response has been received within a predetermined time-out period, the EIF task 2a determines that the sub CPU 202 has never performed any external communication control for the predetermined time-out period and therefore instructs the sub CPU controller 2b to stop supplying the sub CPU 202 with power. The sub CPU controller 2b controls the power supply circuit 208 to selectively supply power to the sub CPU 202 and other components and further controls the clock generator to supply the timing clock to the sub CPU 202. When the EIF 2a is notified by the sub CPU controller 2b that the sub CPU 202 is powered off, the EIF 2a instructs the timer handler 2c to stop the timer for operation check. When the EIF 2a is notified by the sub CPU controller 2b that the sub CPU controller 2b starts supplying the sub CPU 202 with power, the EIF task 2a instructs the timer handler 2c to start the timer for operation check.

The transmission management task 2d manages transmission and reception of messages to and from the sub CPU 202. The DPRAM handler 2e monitors transmission and reception of messages to and from the sub CPU 202.

The sub CPU 202 implements a DPRAM handler 2f, an IDLE task 2g, and a transmission management task 2h. The DPRAM handler 2f monitors transmission and reception of messages to and from the main CPU 201. The IDLE task 2g is an external communication monitoring task that monitors the presence and absence of external communication, for example, radio transmission and reception of control signals to and from the VMCC through a nearest base station (BS). When having received the operation check request primitive from the EIF task 2a of the main CPU 201, the IDLE task 2g sends the monitored result as a response primitive to the operation check request primitive back to the EIF task 2a of the main CPU 201. It should be noted that the lowest task priority is given to the IDLE task 2g so as to avoid the response action of the IDLE task 2g even though some task is not allowed to operate.

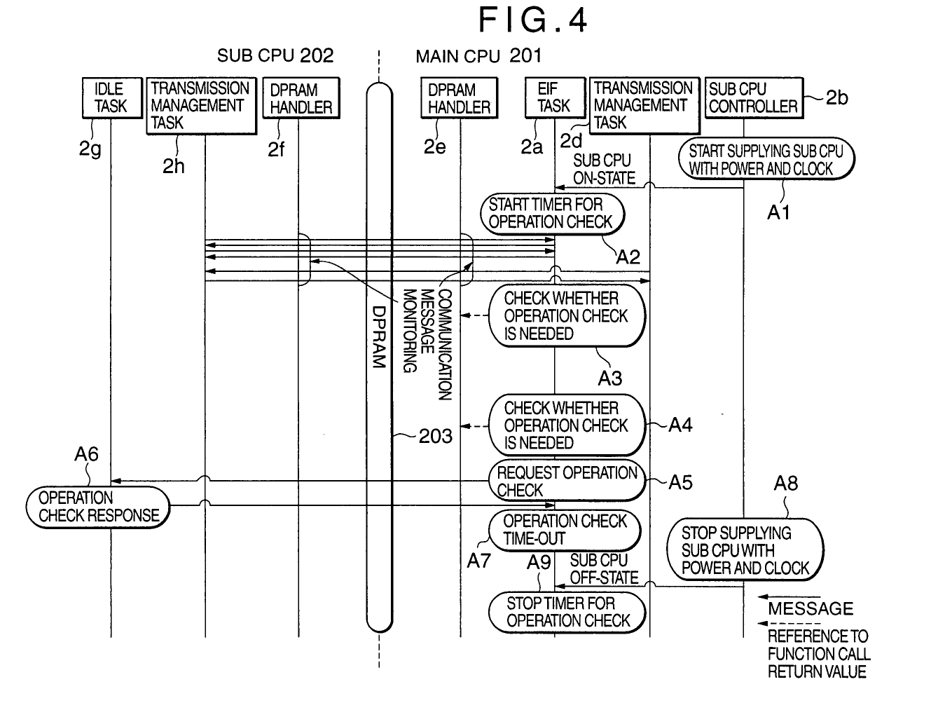

Referring to FIG. 4, in the main CPU 201, the sub CPU controller 2b instructs the power supply circuit 208 to supply power to the sub CPU 201 and the clock generator to supply timing clock to the sub CPU 202 (step A1). When the sub CPU 202 is in power-on state, the sub CPU controller 2b notifies the EIF task 2a that the sub CPU 202 is powered on and thereby the EIF task 2a instructs the timer handler to start the timer for operation check (step A2). Thereafter, messages are transferred through the DPRAM 203 between the EIF task 2a and the transmission management task 2h and between the transmission management tasks 2d and 2h. Such message transfer is monitored by the DPRAM handlers 2e and 2f.

In the case where the EIF task 2a calls on the DPRAM handler 2e to determine whether the operation check is needed before a predetermined time has elapsed from the completion of latest message transfer (step A3), its return value is indicative of “operation check is not needed”. When the EIF task 2a checks the need of operation check after the predetermined time has elapsed from the completion of latest message transfer (step A4), its return value is indicative of “operation check is needed”.

When the operation check is needed, the EIF 2a resets an operation check completion flag to “no response”, instructs the timer handler 2c to set the timer for a predetermined time-out period, and then performs the operation check request to send an operation check request message to the IDLE task 2g (step A5).

When having received the operation check request message from the EIF task 2a, the IDLE task 2g checks whether the external communication control such as the location registration is performed (step A6). When the external communication control is being performed, the IDLE task 2g sends an operation check response message back to the EIF task 2a. The EIF task 2a determines whether the operation check response message is received within the predetermined time-out period. If it is received within the predetermined time-out period, then the EIF task 2a sets the operation check response completion flag to “response received”. If the operation check response message is not received within the predetermined time-out period, then the operation check response completion flag remains set to “no response” and thereby the EIF task 2a starts the operation check time-out processing (step A7).

In the operation check time-out processing (step A7), the EIF task 2a instructs the sub CPU controller 2b to stop supplying the sub CPU 202 with power and timing clock (step A8), sends the transmission management task 2d a message indicating that the sub CPU controller 2b resets the sub CPU 202, and calls on initialization of the DPRAM handler 2e. In addition, the EIF task 2a instructs the DPRAM handler 2e to set the operation check reset flag to “reset by operation check”. When the EIF task 2a is notified of the cub CPU 202 being powered off, the EIF task 2a instructs the timer handler 2c to stop the timer for operation check (step A9). When the sub CPU 202 is powered on, the initialization is performed by looking at the operation check reset flag in the DPRAM 203 indicating that the sub CPU 202 has been reset by the operation check.

The operation check request and response processing (steps A 5 and A6) will be described in details.

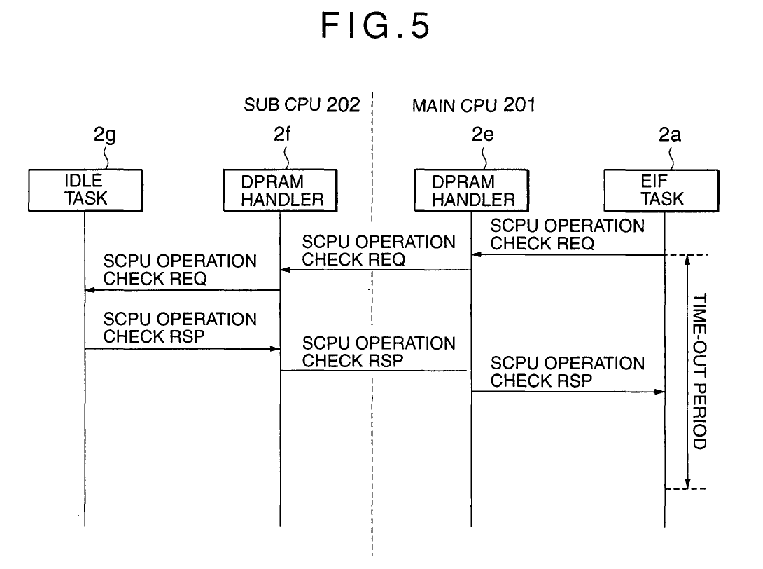

Referring to FIG. 5, the EIF 2a sends an operation check request primitive SCPU₁₃ OPERATION₁₃ CHECK.REQ to the IDLE task 2g through the DPRAM handlers 2e and 2f. When the sub CPU 202 is normally performing the external communication control such as the location registration, the IDLE task2g sends an operation check response primitive SCPU₁₃ OPERATION₁₃ CHECK.RSP back to the EIF 2a through the DPRAM handlers 2f and 2e in response to the operation check request primitive SCPU₁₃ OPERATION₁₃ CHECK.REQ. The time required from transmission of the operation check request primitive SCPU₁₃ OPERATION₁₃ CHECK.REQto reception of the operation check response primitive SCPU₁₃ OPERATION₁₃ CHECK.RSP is normally shorter than the predetermined time-out period as shown in FIG. 5.

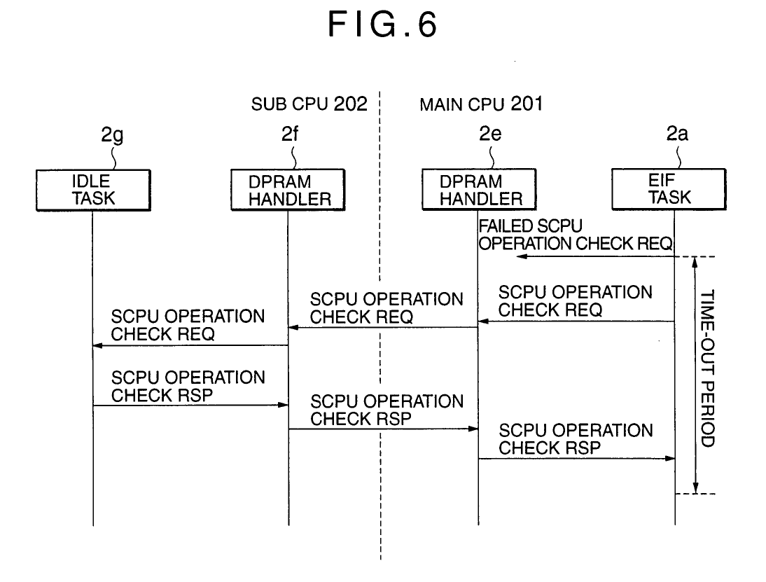

As shown in FIG. 6, when the EIF 2a fails to send the operation check request primitive SCPU₁₃ OPERATION₁₃ CHECK.REQ to the DPRAM handler 2e, the EIF 2atries to send the operation check request primitive SCPU₁₃ OPERATION₁₃ CHECK.REQ again. Accordingly, when the time required from the first failed transmission of the operation check request primitive SCPU₁₃ OPERATION₁₃ CHECK.REQ to the successful reception of the operation check response primitive SCPU_OPERATION_CHECK.RSP is shorter than the predetermined time-out period as shown in FIG. 6, the operation check is successfully completed and it is determined that the sub CPU 202 is normally operating.

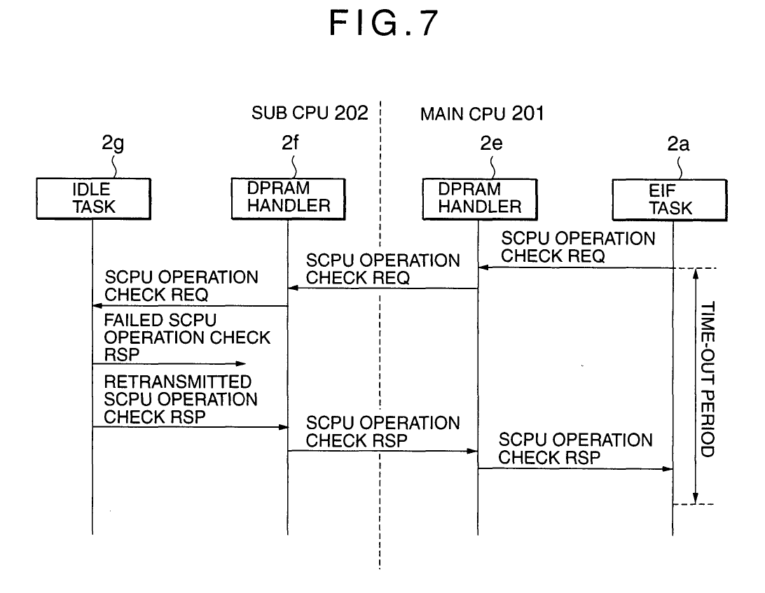

As shown in FIG. 7, the EIF 2a successfully sends the operation check request primitive SCPU_OPERATION_CHECK.REQ to the IDLE task 2g but the IDLE task 2g fails to send an operation check response primitive SCPU_OPERATION_CHECK.RSP back to the DPRAM handler 2f in response to the operation check request primitive SCPU_OPERATION_CHECK.REQ. In this case, the IDLE task 2g tries to send an operation check response primitive SCPU_OPERATION_CHECK.RSP again. Accordingly, when the time required from the transmission of the operation check request primitive SCPU_OPERATION_CHECK.REQ to the successful reception of the operation check response primitive SCPU_OPERATION_CHECK.RSP is shorter than the predetermined time-out period as shown in FIG. 7, the operation check is successfully completed and it is determined that the sub CPU 202 is normally operating.

In the case where transmission and reception of control signals to and from the VMCC are not performed, the IDLE task 2g does not respond to the operation check request primitive SCPU_OPERATION_CHECK.REQ and therefore time-out occurs at the EIF task 2a. There are also other cases that the EIF task 2a fails to transmit the operation check request or receive the operation check response. Several variations of such failed transmission and reception of the operation check response will be described hereafter.

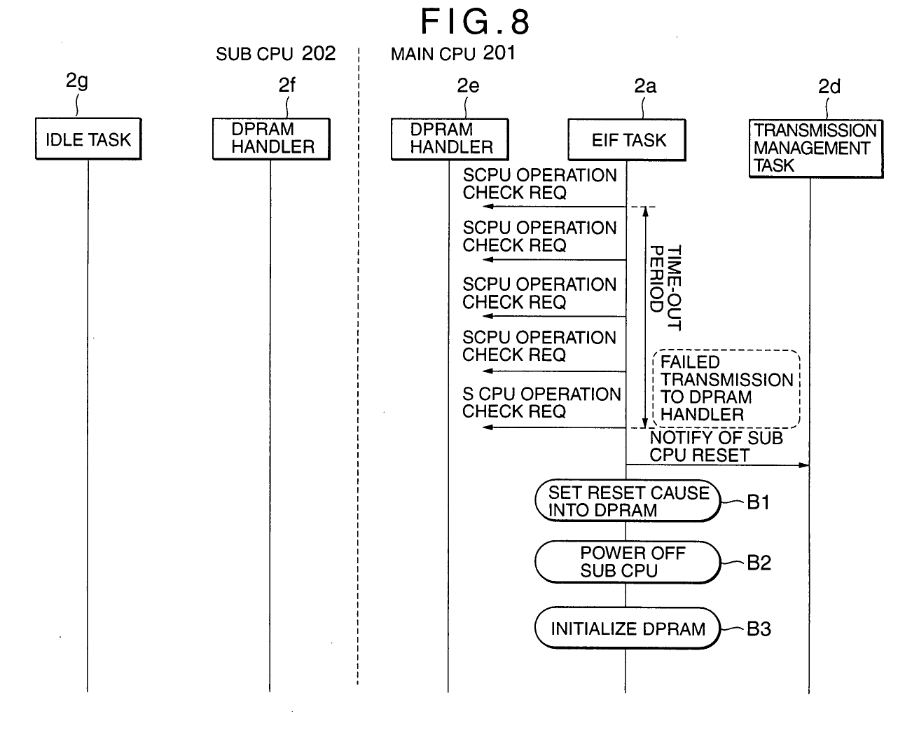

As shown in FIG. 8, when the EIF 2a fails to send the operation check request primitive SCPU_OPERATION_CHECK. REQ to the DPRAM handler 2e, the EIF 2a repeatedly tries to send the operation check request primitive SCPU_OPERATION_CHECK.REQ. When the predetermined time-out period has elapsed from the first transmission of the operation check request primitive SCPU_OPERATION_CHECK.REQ (here, failed transmission is repeated five times), the EIF task 2a notifies the transmission management task 2d that the sub CPU 202 should be reset. Further, the EIF task 2a writes its reset cause into the DPRAM 203 by setting the operation check reset flag of the DPRAM 203 so as to indicate that the sub CPU 202 is reset by the operation check (step B1), instructs the sub CPU controller 2b to stop supplying power to the sub CPU 202 (step B2), and initializes the DPRAM 203 (step B3).

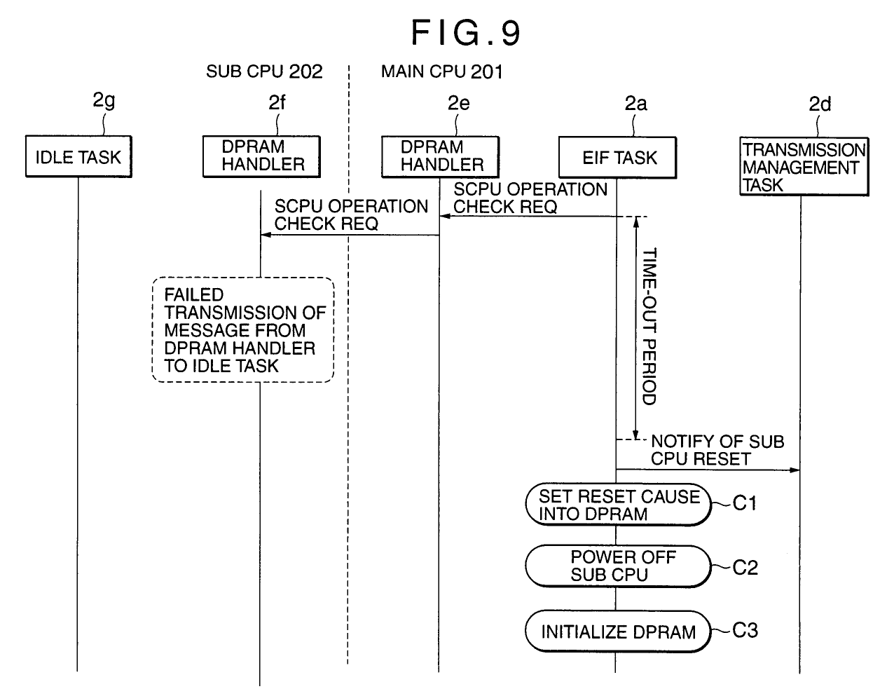

As shown in FIG. 9, the EIF 2a sends the operation check request primitive SCPU_OPERATION_CHECK.REQ to the sub CPU 202 but the DP handler 2f fails to send the operation check request primitive SCPU_OPERATION_CHECK.REQ to the IDLE task 2g. In such a situation, when the predetermined time-out period has elapsed from the transmission of the operation check request primitive SCPU_OPERATION_CHECK.REQ, the EIF task 2a notifies the transmission management task 2d that the sub CPU 202 should be reset. Further, the EIF task 2a writes its reset cause into the DPRAM 203 by setting the operation check reset flag of the DPRAM 203 so as to indicate that the sub CPU 202 is reset by the operation check (step C1), instructs the sub CPU controller 2b to stop supplying power to the sub CPU 202 (step C2), and initializes the DPRAM 203 (step C3).

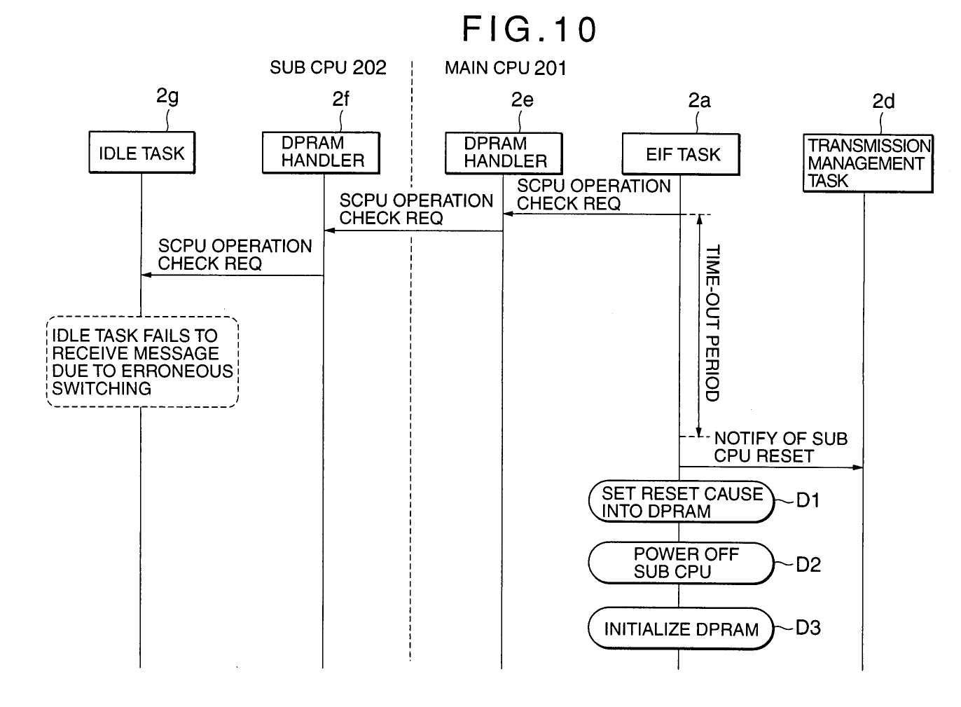

As shown in FIG. 10, the EIF 2a sends the operation check request primitive SCPU_OPERATION_CHECK.REQ to the IDLE task 2g but the IDLE task 2g fails to receive the operation check request primitive SCPU_OPERATION_CHECK.REQ. Such failed reception of the IDLE task 2g may be caused by erroneously switching the operation check request primitive SCPU_OPERATION_CHECK.REQ. In such a situation, when the predetermined time-out period has elapsed from the transmission of the operation check request primitive SCPU_OPERATION_CHECK.REQ, the EIF task 2a notifies the transmission management task 2d that the sub CPU 202 should be reset. Further, the EIF task 2a writes its reset cause into the DPRAM 203 by setting the operation check reset flag of the DPRAM 203 so as to indicate that the sub CPU 202 is reset by the operation check (step D1), instructs the sub CPU controller 2b to stop supplying power to the sub CPU 202 (step D2), and initializes the DPRAM 203 (step D3).

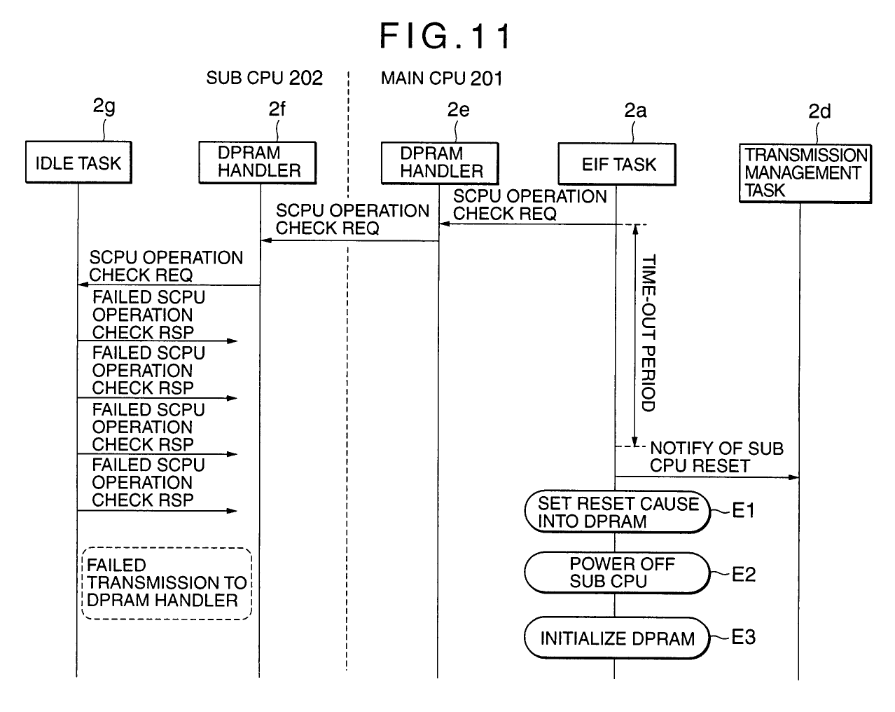

As shown in FIG. 11, the EIF 2a successfully sends the operation check request primitive SCPU_OPERATION_CHECK.REQ to the IDLE task 2g but the IDLE task 2g fails to send an operation check response primitive SCPU_OPERATION_CHECK.RSP back to the DPRAM handler 2f in response to the operation check request primitive SCPU_OPERATION_CHECK.REQ. In this case, the IDLE task 2g tries to send an operation check response primitive SCPU_OPERATION_CHECK.RSP five times. Accordingly, when the predetermined time-out period has elapsed from the transmission of the operation check request primitive SCPU_OPERATION_CHECK.REQ, the EIF task 2a notifies the transmission management task 2d that the sub CPU 202 should be reset. Further, the EIF task 2a writes its reset cause into the DPRAM 203 by setting the operation check reset flag of the DPRAM 203 so as to indicate that the sub CPU 202 is reset by the operation check (step E1), instructs the sub CPU controller 2b to stop supplying power to the sub CPU 202 (step E2), and initializes the DPRAM 203 (step E3).

As described above, according to the embodiment of the present invention, when the time required from transmission of the operation check request to reception of its response exceeds the predetermined time-out period or the response fails to be received within the predetermined time-out period, it is determined that no external communication control is performed by the sub CPU 202 and therefore the EIF task 2a instructs the sub CPU controller 2b to stop supplying power to the sub CPU 202, resulting in reduced power consumption and elongated lifetime of the battery.

The present invention is not limited to the above-described embodiment in which the mobile telephone 20 is connected to the base station by radio. The present invention can be applied to another embodiment in which the mobile telephone 20 is connected to a personal computer 212 by the external connector 211 because the sub CPU 202 controls the transmission and reception of messages to and from the personal computer 212. Further, the present invention can be applied to any type of battery-powered multi-controller mobile station equipped with a main controller for controlling the entire operation thereof and a sub controller for controlling the external communication.

1. A power supply control method in a portable communication device provided with a plurality of controllers including a main controller and a sub controller for controlling external communication, comprising the steps of:
a) checking whether the sub controller is performing the external communication; and
b) when the external communication has not been performed for a predetermined time-out period, powering off the sub controller.

2. The power supply control method according to claim 1, wherein the external communication is radio communication with a mobile communications system for location registration of the portable communication device.

3. The power supply control method according to claim 1, wherein the external communication is wired communication with an external information processing device through an external connector.

4. The power supply control method according to claim 1, wherein
the step a) comprises the steps of:
a.1) sending an operation check request to the sub controller when an operation check timer is reset for the predetermined time-out period; and
a.2) determining whether an operation check response to the operation check request is received from the sub controller, and
the step b) comprises the steps of:
b.1) when the operation check response is not received from the sub controller within the predetermined time-out period, powering off the sub controller; and
b.2) when the operation check response is received from the sub controller within the predetermined time-out period, keeping the sub controller powered on.

5. The power supply control method according to claim 4, further comprising the steps of:
implementing at least an external interface task and timer handler in the main controller; and
implementing at least an external communication monitoring task in the sub controller,
wherein the external interface task sends the operation check request when the timer handler starts the operation check timer and, when the operation check response is not received from the sub controller within the predetermined time-out period, powers off the sub controller,
wherein the external communication monitoring task sends the operation check response back to the external interface task when the external communication is being performed.

6. A power supply control system in a portable communication device provided with a plurality of controllers including a main controller and a sub controller for controlling external communication, comprising:
operation check means for checking whether the sub controller is performing the external communication; and
power control means controlling power supply of the sub controller such that the sub controller is powered off when the external communication has not been performed for a predetermined time-out period.

7. The power supply control system according to claim 6, wherein
the operation check means sends an operation check request to the sub controller when an operation check timer is reset for the predetermined time-out period, and determines whether an operation check response to the operation check request is received from the sub controller, and
the power control means powers off the sub controller when the operation check response is not received from the sub controller within the predetermined time-out period, and keeping the sub controller powered on when the operation check response is received from the sub controller within the predetermined time-out period.

8. The power supply control system according to claim 7, wherein the sub controller sends the operation check response back to the main controller when the external communication is being performed.

9. A portable communication device comprising:
a radio communication section for communicating with a base station of a mobile communications system;
a main CPU for controlling an entire operation of the portable communication device;
a sub CPU for controlling external communication;
a dual port memory connected to the main CPU at one port and connected to the sub CPU at the other port, for transferring messages between the main CPU and the sub CPU,
wherein the main CPU implements:
operation check means for checking whether the sub controller is performing the external communication; and
power control means controlling power supply of the sub controller such that the sub controller is powered off when the external communication has not been performed for a predetermined time-out period,
wherein the sub controller implements:
response means for sending the operation check response back to the main controller when the external communication is being performed.

10. A computer program instructing a computer to implement a power supply control method in a portable communication device provided with a plurality of controllers including a main controller and a sub controller for controlling external communication, the program comprising the steps of:
a) checking whether the sub controller is performing the external communication; and
b) when the external communication has not been performed for a predetermined time-out period, powering off the sub controller.

11. The computer program according to claim 10, wherein
the step a) comprises the steps of:
a.1) sending an operation check request to the sub controller when an operation check timer is reset for the predetermined time-out period; and
a.2) determining whether an operation check response to the operation check request is received from the sub controller, and
the step b) comprises the steps of:
b.1) when the operation check response is not received from the sub controller within the predetermined time-out period, powering off the sub controller; and
b.2) when the operation check response is received from the sub controller within the predetermined time-out period, keeping the sub controller powered on.

12. The computer program according to claim 11, further comprising the steps of:
implementing at least an external interface task and timer handler in the main controller; and
implementing at least an external communication monitoring task in the sub controller,
wherein the external interface task sends the operation check request when the timer handler starts the operation check timer and, when the operation check response is not received from the sub controller within the predetermined time-out period, powers off the sub controller,
wherein the external communication monitoring task sends the operation check response back to the external interface task when the external communication is being performed.
